(19) United States
(12) Patent Application Publication
(10) Pub. No.: US 2026/0225742 A1
(43) Pub. Date: Aug. 6, 2026

(54) VEHICLE BASED DRONE

(71) Applicant: BENTLEY MOTORS LIMITED, Crewe (GB)

(72) Inventors: Jose María Ortega HERNANDEZ, Crewe (GB); Iain Tough, Crewe (GB)

(21) Appl. No.: 19/149,427

(22) PCT Filed: Jan. 18, 2024
(86) PCT No.: PCT/GB2024/050136

§ 371 Date: Jul. 18, 2025

(30) Foreign Application Priority Data
Jan. 18, 2023 (GB) 2300752.9

(51) Int. Cl. B64U 80/86; B64U 10/14; B64U 10/80; B64U 20/00; B64U 70/93; B64U 70/99; B64U 101/30; G05D 1/686; G05D 1/689; G05D 105/80; G05D 109/25

(52) U.S. Cl. CPC B64U 80/86; B64U 10/14; B64U 10/80; B64U 20/00; B64U 70/93; B64U 70/99; G05D 1/686; G05D 1/689; B64U 2101/30; G05D 2105/87; G05D 2109/254

(57) ABSTRACT

The present invention relates to a vehicle comprising a mascot mounted via a drone and to a drone comprising a mascot configured to be secured to a vehicle to mount the mascot thereto. The present invention also relates to a method of providing one or more images along a navigation route using a drone, and a method for locating a vehicle using a drone.

### TECHNICAL FIELD OF THE INVENTION

The present invention relates to a vehicle comprising a mascot mounted via a drone and to a drone comprising a mascot, together with methods of operating a drone.

### BACKGROUND TO THE INVENTION

Vehicles comprising mascots are known in the art.

Mascots typically include ornamental objects which project from the surface of a vehicle.

Mascots act as distinguishing features for the vehicle and may comprise a statue, emblem, figurine, character, letter, or logo that projects outwardly from the surface of the vehicle.

Similarly, methods of mounting mascots on vehicles are known in the art.

Typically, in light of modern regulations concerning ornaments that project from vehicles, for new cars these methods allow for the mascot to be retractable by use of a track, such as described in EP3980297, or other similar retraction mechanism.

However, such methods for securing the mascot to the vehicle do not allow the mascot to provide any additional functionality or driver assistance.

Similarly, it is known in the art to integrate drones into vehicles as described in US2020216196 and U.S. Pat. No. 10,152,059. However, the drones often do not blend seamlessly when attached to the vehicle and act as an ‘eyesore’.

It is an aim of the present invention to provide a vehicle having a mascot with greater functionality.

It is also an aim of the present invention to provide a vehicle comprising a drone with an improved appearance.

It is also an aim of the present invention to provide an improved method of locating a vehicle using a drone.

It is also an aim of the present invention to provide an improved method of providing one or more images along a road using a drone.

It is also an aim of embodiments of the invention to overcome or mitigate at least one problem of the prior art, whether expressly described herein or not.

### SUMMARY OF THE INVENTION

According to a first aspect of the invention there is provided a vehicle comprising a mascot; the mascot mounted to the vehicle via a drone.

Such a vehicle is able to provide a mascot with improved functionality, together with providing a feature which is able to “surprise and delight” customers.

By the term “drone” it is meant an unmanned aerial vehicle (UAV).

The drone may comprise a body having an upper and lower surface.

The upper surface of the body of the drone may comprise a mascot located thereon.

The mascot may comprise an ornament.

The ornament may be a statue, emblem, figurine, character, letter, logo or any other ornamental object.

In one embodiment, the mascot may have a base portion for securing to the top surface of the body of the drone and an upper portion.

The base portion may be a plinth. The plinth may have a generally polygonal shape, such as square, rectangular, diamond shaped, trapezoidal or hexagonal shape, such as a coffin shape. The shape may have curved corners and may be elongate.

The base portion may be secured to the drone using any conventional fixing means in the art. Example of suitable means may include, but are not limited to, one or more screws, adhesive, welding or other fixing means.

The upper portion may comprise an ornament.

The ornament may be a statue, emblem, figurine, character, letter, logo or any other ornamental object.

In some embodiments, the mascot may also comprise a connecting portion suitable for connecting the upper portion to the base potion.

In such embodiments, the connecting portion may comprise a stem, pole or other supporting structure suitable for connecting the upper portion to the base portion.

For example, in one embodiment, the mascot may comprise a base portion and a connecting portion and an upper portion, wherein the base portion comprises a plinth, the connecting portion comprises a stem and the upper portion comprises a logo or letter.

In one embodiment of the present invention, the mascot may comprise one or more lights.

In such an embodiment, the base portion, connecting portion and/or upper portion may comprise one or more lights.

In one embodiment, the mascot may be at least partially formed from a semi-transparent material.

Preferably, the upper portion of the mascot may be at least partially formed from a semi-transparent material.

In such an embodiment, the one or more lights may be configured to illuminate at least a part of the upper portion of the mascot.

The lower surface of the body of the drone may comprise one or more connection points configured to secure the drone to the vehicle.

The lower surface of the body of the drone may comprise one or more mechanical connection points configured to connect to the vehicle.

The one or more mechanical connections may be any suitable mechanical connection known in the art. Examples of suitable mechanical connections include, but are not limited to, cables, wires, latches, screws, pins, tethers and other suitable mechanical connections.

The lower surface of the body of the drone may comprise one or more magnetic connection points configured to connect to the vehicle.

The magnetic connection points may comprise a ferromagnetic material. Preferably the magnetic connection point is a magnet.

The vehicle may comprise one or more landing points.

In such an embodiment, the landing point is suitable for connecting to the drone.

The landing point may be located on an outer surface of the vehicle.

In such an embodiment, the landing point may be located at the front or rear of the vehicle.

Preferably, the landing point is located at the front of the vehicle.

More preferably, the landing point is located at the front and centre of the vehicle.

Most preferably, the landing point is located in front of a hood or bonnet of the vehicle, preferably located centrally in front of a hood or bonnet of the vehicle.

The landing point may be configured to mechanically connect to the drone.

In such embodiments, the landing point may have one or more mechanical connection points configured to connect to the drone.

The one or more mechanical connections may be any suitable mechanical connection known in the art. Examples of suitable mechanical connections include, but are not limited to, cables, wires, latches, screws, pins, tethers and other suitable mechanical connections.

In such an embodiment, the drone may also have one or more mechanical connection points located on its lower surface that are suitable to mechanically connect to the mechanical connection points on the landing point of the vehicle.

The landing point may be configured to magnetically connect to the drone.

In such an embodiment, the landing point may comprise one or more magnetic connection points configured to connect to the drone.

The magnetic connection points may be a magnet. Preferably, the magnet is an electromagnet. Most preferably, the magnet is an electromagnet connected to a battery of the vehicle.

In such an embodiment, the drone may also have one or more magnetic connection points located on its lower surface, as described above, that are configured to magnetically connect with the one or more magnetic connection points on the landing point.

In a further embodiment of the invention, the landing point may be configured to mechanically and magnetically connect to the drone.

In such an embodiment, the landing point may comprise one or more magnetic connection points and one or more mechanical connection points configured to connect to the drone.

The magnetic connection points and mechanical connection points may be as described above.

The landing point may include one or more sensors capable of sensing whether the drone is occupying the landing point.

The one or more sensors may confirm the landing status of the drone.

Preferably, the sensor may be a pressure sensor.

The one or more sensors may be integrated into a surface of the landing point or otherwise associated therewith.

The landing point may be configured to communicate with and/or provide power to the drone via one or more power and/or communications connections.

The power and/or communication connections may be in the form of cables.

In such embodiments, the sensor may be an electrical sensor.

In one embodiment, the landing point may be configured to communicate with the drone via a two-dimensional code. The two dimensional code may be located on a surface of the landing point. Preferably, the two-dimensional code is a quick response (QR) code.

The two dimensional code may be used by the drone to recognise the vehicle and/or for the vehicle to confirm the landing status of the drone.

In one embodiment of the invention, the landing point may be located within an aperture located on an outer surface of the vehicle.

In such embodiments, the aperture may be located at the front or rear of the vehicle. Preferably, the aperture is located at the front of the vehicle.

More preferably, the aperture is located at the front and centre of the vehicle.

Most preferably, the aperture is located in front of a hood or bonnet of the vehicle, preferably located centrally in front of a hood or bonnet of the vehicle.

The aperture may comprise a pocket in which the landing point is located. The pocket may be formed behind the aperture.

The pocket may be illuminated.

In such an embodiment, the pocket may comprise one or more lamps to illuminate a region behind the aperture, e.g. the pocket.

The vehicle may comprise one or more cover plates having an outer surface arranged to close the aperture.

The cover plate may be arranged to close the aperture such that the outer surface of the cover plate is flush around the base portion of the mascot in a first closed position.

In such an embodiment, when the cover plate is in a first closed position, the outer surface of the cover plate conceals the body of the drone when the drone is connected to the landing point. Beneficially, this allows only the mascot to be visible when the drone is connected to the vehicle.

Preferably, the cover plate is configured to enter the first closed position when the landing point is occupied.

In such an embodiment, the vehicle may recognise the connection of the drone with the landing point and in response may send a first ‘close’ signal to the cover plate to enter the first closed position. The cover plate may also be arranged to fully close the aperture in a second closed position. In such an embodiment, the outer surface of the cover plate may be arranged to fully conceal the aperture and to be flush with the exterior surface of the vehicle in a second closed position.

Preferably, the cover plate is configured to fully close the aperture and enter the second closed position when the landing point is vacant.

In such an embodiment, the vehicle may recognise the vacancy of the landing point and may in response send a second ‘close’ signal to the cover plate to enter the second closed position.

The cover plate may be configured to open the aperture and enter an open position.

The cover plate may be configured to open the aperture and enter an open position when a first ‘open’signal is provided.

The ‘open’ signal may be provided by pressing a button to deploy the drone on a key, vehicle infotainment system, smart phone or other electronic device.

The ‘open’ signal may be provided by the drone approaching and in close vicinity to the cover plate.

In such an embodiment, the drone may communicate with the vehicle to provide the ‘open’signal.

In a further embodiment of the invention, the cover plate may enter the second ‘closed’ position and the landing plate may lower such that the drone body and mascot are concealed beneath the cover plate.

In such an embodiment, the vehicle may send a third ‘close’ signal to the cover plate and landing point to actuate the cover plate to enter the second closed position and to lower the landing point.

The third ‘close’ signal may be provided pressing a lock button on a key, for example a remote ignition key, or pressing a lock button on a smart device, such as a smart phone or other electronic device. Various other inputs may also send the third ‘close’ signal for example, pressing a ‘retract’ button on an infotainment system and so forth.

Beneficially, this allows the entirety of the drone to be secured inside of the vehicle to prevent theft or damage.

In such an embodiment, the vehicle may send a second ‘open’ signal to the cover plate and landing point to actuate the opening of the cover plate to the first ‘closed’ position and the landing point may raise such that the outer surface of the cover plate conceals the body of the drone and the mascot extends through the cover plate.

The second ‘open’ signal may be provided by pressing an unlock button on a key, for example a remote ignition key, auto detection using keyless entry, operating a door handle or pushing of an ignition button or turning an ignition key. Various other inputs may also send the second ‘open’ signal for example, pressing an unlock button on a smart phone or other electronic device, and so forth.

The various ‘closed’ position may be provided by the same cover plate. Alternatively, the various ‘closed’ positions may be provided by a different cover plate. For example, in one embodiment, a first cover plate may enter the first ‘closed’ position and a second cover plate may enter the second ‘closed’position.

Alternatively, or additionally, the vehicle may have one or more sensors located within the aperture. The one or more sensors may include a light curtain sensor, an ultrasonic sensor, an infrared sensor, a laser sensor (e.g. lidar), radar, or a combination thereof.

In such an embodiment, the ‘open’ signal may be provided by the drone triggering the one or more sensors located within the aperture.

The second ‘close’ signal may be provided automatically when the drone is located away from the vehicle. In such an embodiment, the vehicle may recognise the vacancy of the landing point and thereby send a ‘close’ signal for the cover plate to move from an open position to the second closed position.

The cover plate may be connected to a drive mechanism which facilitates the open and closure of the cover plate in response to the ‘open’or ‘close’signal.

The drive mechanism may be electronic or mechanical.

The landing point may also be connected to a drive mechanism which facilitates the raising and lowering of the landing point as described above.

The drive mechanism may be electronic or mechanical.

The landing point may be in communication with the vehicle.

Preferably, the landing point is in electrical communication with the vehicle's electronic systems, preferably a vehicle's infotainment system.

Preferably, the landing point is in electrical communication with the vehicle via one or more cables.

The drone may comprise one or more propellers. The drone may comprise one, two, three, four, or five propellers. The drone may comprise a plurality of propellers.

Preferably, the propellers are connected to the body of the drone.

The drone may comprise one or more processors.

Preferably, the drone may communicate with the vehicle via a processor.

The processor may also be capable of communicating with a further device.

The further device may be a computer, a smart phone, laptop, and/or tablet among others.

Preferably, the drone is configured to communicate with the vehicle's electronic systems, more preferably a vehicle's infotainment system.

The drone may be configured to communicate with the vehicle and/or further device via radio frequency, Wi-Fi, Bluetooth, infrared, cellular communication networks such as 3G, 4G or 5G networks and/or a satellite communication network.

The drone may comprise a navigation system so that it can fly to, and hover at, a particular location.

The drone may comprise a global positioning system (GPS). The GPS may be used for determining the position of the drone with respect to the vehicle (which of course may also comprise a GPS). The GPS may be used to trigger the “open” signal to open the aperture.

The drone may further comprise a memory, one or more displays, one or more image sensors, one or more motion sensors, one or more positioning sensors, one or more power sources and/or a communication unit.

Preferably, the power source is a battery, such as a lithium ion battery. The power source may be powered by a charging device such as a car battery.

The communication unit may send information, such as image information, navigation information, position information, movement information to the vehicle and/or a further device.

The communication unit may receive information, such as image information, navigation information, position information, movement information from the vehicle and/or a further device.

The position information may be information relating to the position of the drone such as roll, pitch, yaw, distances and/or heading.

The movement information may be information relating to the movement of the drone such as velocity and/or acceleration.

The image sensors may be arranged to obtain one or more images. The images may be digital images or video.

Preferably, the image sensor is one or more cameras.

In one embodiment, the image sensor may be configured to identify the vehicle. For example, the image sensor may be configured to identify the vehicle by identifying a QR code on a surface of the vehicle.

The motion sensors may be arranged to obtain one or more movement information. Preferably, the motion sensor comprises an accelerometer.

The positioning sensors may be arranged to determine the position of the drone.

The memory may store instructions and/or data.

The processor may access the memory. The processor may access the memory by reading from and/or writing to the memory.

The memory may store instructions and/or data relating to the image information, navigation information, position information, and/or movement information

The weight of the drone, including the mascot, may be no more than 250 g, 240 g, 230 g, 225 g, 220 g, 210 g, or 200 g.

Beneficially, drones of such size may be operated in many territories without the need for additional flying qualifications or permits. Moreover, a drone of this weight does not add unnecessary weight to the vehicle.

Preferably, the vehicle is an automobile, such as a passenger car.

In a second aspect of the invention, there is provided a drone comprising a mascot, wherein the drone is configured to be secured to a vehicle to mount the mascot thereto.

The drone may be as described in the first aspect of the invention.

The drone may be secured to the vehicle as described in the first aspect of the invention.

In a third aspect of the present invention, there is provided a method of providing one or more images along a navigation route comprising: deploying a drone to fly to one or more points along a navigation route between a start position and a user inputted final destination, taking one or more images at the one or more points, sending the images to a vehicle and displaying said images via a display inside the vehicle.

Beneficially, the method allows the driver to determine the road situation ahead. This may be useful to determine traffic conditions along a route and/or may allow the user of the vehicle to determine the cause of any traffic jams, which may allow them to better determine a new route.

The drone may comprise one or more propellers, one or more processors, a memory, one or more displays, one or more image sensors, one or more motion sensors, one or more positioning sensors, one or more power sources and/or a communication unit, as described in the first aspect of the invention.

To deploy the drone, the vehicle may output an ‘open’signal to an actuator.

In response to the ‘open’ signal, the actuator may open an aperture of the vehicle.

The aperture may include but is not limited to a door, trunk or cover plate such as described in the first aspect of the invention.

Once released from the vehicle, the vehicle may send a command for the drone to fly to one or points along a navigation route between a start position and a user inputted final destination.

Preferably, the vehicle and drone comprise communication units operable to exchange data via a communication network.

The communication network may be a radio frequency, Wi-Fi, Bluetooth, a cellular communication network and/or a satellite communication network. Suitable cellular communication networks include but are not limited to 3G, 4G or 5G networks.

In one embodiment of the invention, the command may be provided from the vehicle to the drone via a remote server.

In such an embodiment, the vehicle may be in wireless communication with the remote server through the communication network and the remote server may wirelessly communicate with the drone through the communication network.

Alternatively, the command may be provided directly from the vehicle to the drone.

In such an embodiment, the vehicle may be in wireless communication with the drone. Preferably, the vehicle is in direct wireless communication with the drone through the communication network.

Preferably, the drone comprises a drone navigation system.

Preferably, the vehicle comprises a vehicle navigation system.

The drone navigation system may be in communication with the vehicle's navigation system via the communication network.

The drone navigation system may be operable to receive from the vehicle the location of one or more points and develop a route from the vehicle to the points.

Preferably, the drone navigation system may be operable to receive from the vehicle's navigation system the location of one or more points and develop a route from the vehicle to the points.

Once at the points, the drone may be programmed to take one or more images of the road.

In such an embodiment, the drone comprises an image sensor. Preferably, the image sensor is a camera.

The images may be sent from the drone to a remote server.

In such an embodiment, the drone may wirelessly communicate with the remote server through the communication network.

The remote server may send the images to the vehicle.

The remote server may send the images to a mobile device, computer and/or tablet.

The images may be transmitted from the remote server to the vehicle, mobile device, computer and/or tablet wirelessly through the communication network.

Alternatively, the images may be transmitted from the drone directly to the vehicle without a remote server.

In such embodiments, the drone may be in direct wireless communication with the vehicle through the communication network.

The images may be displayed on a display inside of the vehicle. Preferably, the display is associated with an infotainment system of the vehicle.

In one embodiment, the drone described in the third aspect may be a drone according to a first aspect of the present invention.

In a fourth aspect of the present invention, there is provided a method for locating a vehicle, the method comprising: sending a deployment signal to a vehicle, deploying a drone from the vehicle in response to receiving the deployment signal, configuring the drone to hover above the vehicle and configuring said drone to provide one or more alerts.

Beneficially, this allows a user to locate the vehicle in a crowded parking space or when the location of the vehicle is unknown.

The drone may comprise one or more propellers, one or more processors, a memory, one or more displays, one or more image sensors, one or more motion sensors, one or more positioning sensors, one or more power sources and/or a communication unit, as described in the first aspect of the invention.

In some embodiments, the drone may be configured to hover over the vehicle.

In such an embodiment, the drone may be configured to hover over the vehicle at a distance of at least 0.1, 0.5, 1.0, 1.5, 2.0, 2.5 or at least 3.0m directly upwards from the vehicle. The drone may be configured to hover over the vehicle at a distance of no more than 3.0, 2.5, 2.0, 1.5, 1.0, 0.5 or no more than 0.1 m directly upwards from the vehicle. The drone may be configured to hover over the vehicle at a distance of from 0.1-3.0 m, 0.1-2.5 m, 0.1-2.0 m, 0.1-1.5 m or from 0.1-1 m directly upwards from the vehicle.

In some embodiments, the drone may be configured to hover above and in front of the vehicle.

In such an embodiment, the drone may be configured to hover above and in front of the vehicle at a distance of at least 0.1, 0.5, 1.0, 1.5, 2.0, 2.5 or at least 3.0m from the vehicle. The drone may be configured to hover above and in front of the vehicle at a distance of no more than 3.0, 2.5, 2.0, 1.5, 1.0, 0.5 or no more than 0.1m from the vehicle. In some embodiments, the drone may be configured to hover above and in front of the vehicle at a distance of from 0.1-3.0 m, 0.1-2.5 m, 0.1-2.0 m, 0.1-1.5 m or from 0.1-1 m from the vehicle.

In some embodiments, the drone may be configured to hover above and to the left or right of the vehicle.

In such an embodiment, the drone may be configured to hover above and to the left or right of the vehicle at a distance of at least 0.1, 0.5, 1.0, 1.5, 2.0, 2.5 or at least 3.0m from the vehicle. The drone may be configured to hover above and to the left or right of the vehicle at a distance of no more than 3.0, 2.5, 2.0, 1.5, 1.0, 0.5 or no more than 0.1 m from the vehicle. In some embodiments, the drone may be configured to hover above and to the left or right of the vehicle at a distance of from 0.1-3.0 m, 0.1-2.5 m, 0.1-2.0 m, 0.1-1.5 m or from 0.1-1 m from the vehicle.

In some embodiments, the drone may be configured to hover above and to the rear of the vehicle.

In such an embodiment, the drone may be configured to hover above and to the rear of the vehicle at a distance of at least 0.1, 0.5, 1.0, 1.5, 2.0, 2.5 or at least 3.0 m from the vehicle. The drone may be configured to hover above and to the rear of the vehicle at a distance of no more than 3.0, 2.5, 2.0, 1.5, 1.0, 0.5 or no more than 0.1 m from the vehicle. In some embodiments, the drone may be configured to hover above and to the rear of the vehicle at a distance of from 0.1-3.0 m, 0.1-2.5 m, 0.1-2.0 m, 0.1-1.5 m or from 0.1-1 m from the vehicle.

Preferably, the vehicle and drone comprise communication units operable to exchange data via a communication network.

The communication network may be a radio frequency, Wi-Fi, Bluetooth, a cellular communication network and/or a satellite communication network. Suitable cellular communication networks include but are not limited to 3G, 4G or 5G networks.

In one embodiment, the deployment signal may be provided by a remote server.

The remote server may initiate the deployment signal in response to a user input.

In such an embodiment, the drone may wirelessly communicate with the remote server through the communication network.

The user input may be provided by a user through a mobile device, button on a remote ignition key, computer and/or tablet.

The user input may be transmitted to the remote server through the communication network.

The remote server may communicate the user input to the vehicle via the communication network.

In such embodiments, the vehicle may wirelessly communicate with the remote server through the communication network.

Alternatively, the deployment signal may be provided directly from the vehicle.

In such an embodiment, the vehicle may wirelessly communicate directly with the drone through the communication network.

In one embodiment, the deployment signal may be provided by pressing a button on a vehicle infotainment system.

Beneficially, the ability to send the deployment signal via a vehicle infotainment system allows the occupant of the vehicle to be more easily located such as, for example, when requiring emergency assistance or when a passenger is approaching.

In another embodiment, the deployment signal may be provided by pressing a button on a remote ignition key or smart device, such as a smart phone or tablet.

In such an embodiment, the remote ignition key or smart device may comprise a communication unit operable to exchange data via the communication network as described above.

The remote ignition key or smart device may wirelessly communicate with the remote server through the communication network.

Alternatively, the remote ignition key or smart device may wirelessly communicate directly with the drone through the communication network.

To deploy the drone, the vehicle may output an ‘open’signal to an actuator.

In response to the ‘open’ signal, the actuator may open an aperture on the vehicle.

The aperture may be a door, trunk or cover as described in the first aspect of the invention of the vehicle.

After deployment of the drone, the vehicle may send a command for the drone to exit the vehicle and hover above the vehicle.

The command may be transmitted from the vehicle to the drone via a remote server as described above.

Alternatively, the command may be transmitted directly to the drone via the vehicle as described above.

Once above the vehicle, the vehicle may send a command for the drone to activate one or more alerts.

The alerts may be one or more lights and/or alarms.

In an embodiment wherein the drone is a drone according to the first aspect of the invention, the mascot may comprise the one or more lights.

In another embodiment of the invention, after deployment of the drone, the vehicle may send a command for the drone to exit the vehicle and locate the user.

In such an embodiment, after deployment of the drone, the vehicle may send a command for the drone to exit the vehicle and fly to the location of the user's position via the communication network.

In such an embodiment, the remote ignition key or smart device may comprise a navigation system operable to send a location of the user's position to the vehicle and/or drone via the communication network.

After receiving the command, the method may comprise the step of the drone flying to the user's position.

The step of the drone flying to the user's position may also comprise activating one or more lights and/or an alarm.

Once at the user's position, the vehicle may then send a command for the drone to return to the vehicle.

In such an embodiment, the navigation system of the vehicle may send the location of the vehicle to the drone via the communication network.

After, receiving the command for the drone to return to the vehicle, the method may further comprise the step of the drone flying back to the vehicle.

The step of the drone flying back to the vehicle may also comprise the step of the drone activating one or more lights and/or an alarm.

Beneficially, this allows the drone to guide the user to the location of the vehicle.

The drone described in the fourth aspect of the invention may be a drone according to a first aspect of the invention.

In a fifth aspect of the present invention, there is provided a method for locating a vehicle, the method comprising: sending a deployment signal to a vehicle; deploying a drone from the vehicle in response to receiving the deployment signal; sending a command for the drone to exit the vehicle and locate the user; configuring the drone to fly to the user's position after receiving the command for the drone to exit the vehicle and locate the user; sending a command for the drone to return to the vehicle; configuring the drone to fly back to the vehicle after receiving the command for the drone to return to the vehicle.

Beneficially, this method allows the drone to guide the user to the location of the vehicle.

The drone may comprise one or more propellers, one or more processors, a memory, one or more displays, one or more image sensors, one or more motion sensors, one or more positioning sensors, one or more power sources and/or a communication unit, as described in the first aspect of the invention.

Preferably, the vehicle and drone comprise communication units operable to exchange data via a communication network.

The communication network may be a radio frequency, Wi-Fi, Bluetooth, a cellular communication network and/or a satellite communication network. Suitable cellular communication networks include but are not limited to 3G, 4G or 5G networks.

In one embodiment, the deployment signal may be provided by a remote server.

The remote server may initiate the deployment signal in response to a user input.

In such an embodiment, the drone may wirelessly communicate with the remote server through the communication network.

The user input may be provided by a user through a mobile device, remote ignition key, computer and/or tablet.

The user input may be transmitted to the remote server through the communication network.

The remote server may communicate the user input to the vehicle via the communication network.

In such embodiments, the vehicle may wirelessly communicate with the remote server through the communication network.

Alternatively, the deployment signal may be provided directly from the vehicle.

In such an embodiment, the vehicle may wirelessly communicate directly with the drone through the communication network.

In one embodiment, the deployment signal may be provided by pressing a button on a vehicle infotainment system.

Beneficially, the ability to send the deployment signal via a vehicle infotainment system allows the occupant of the vehicle to be more easily located such as, for example, when requiring emergency assistance or when a passenger is approaching.

In another embodiment, the deployment signal may be provided by pressing a button on a remote ignition key or smart device, such as a smart phone or tablet.

In such an embodiment, the remote ignition key or smart device may comprise a communication unit operable to exchange data via the communication network as described above.

The remote ignition key or smart device may wirelessly communicate with the remote server through the communication network.

Alternatively, the remote ignition key or smart device may wirelessly communicate directly with the drone through the communication network.

In one embodiment, the command to exit the vehicle and locate the user may be provided by the vehicle.

In one embodiment, the command for the drone to return to the vehicle may be provided by the vehicle.

To deploy the drone, the vehicle may output an ‘open’signal to an actuator.

In response to the ‘open’ signal, the actuator may open an aperture on the vehicle.

The aperture may be a door, trunk or cover, as described in the first aspect of the invention, of the vehicle.

The drone may comprise one or more lights and/or alarms.

In an embodiment wherein the drone is a drone according to the first aspect of the invention, the mascot may comprise the one or more lights.

The step of the drone flying to the user's position may also comprise activating one or more lights and/or a alarm.

The navigation system of the vehicle may send the location of the vehicle to the drone via the communication network.

The step of the drone flying back to the vehicle may also comprise the step of the drone activating one or more lights and/or an alarm.

Beneficially, this allows the drone to guide the user to the location of the vehicle.

The drone described in the fifth aspect of the invention may be a drone according to a first aspect of the invention.

The further aspects of the present invention may incorporate any of the features of the other aspects of the invention described herein as desired or as appropriate.

### DETAILED DESCRIPTION OF THE INVENTION

In order that the invention may be more clearly understood one or more embodiments thereof will now be described, by way of example only, with reference to the accompanying drawings, of which:

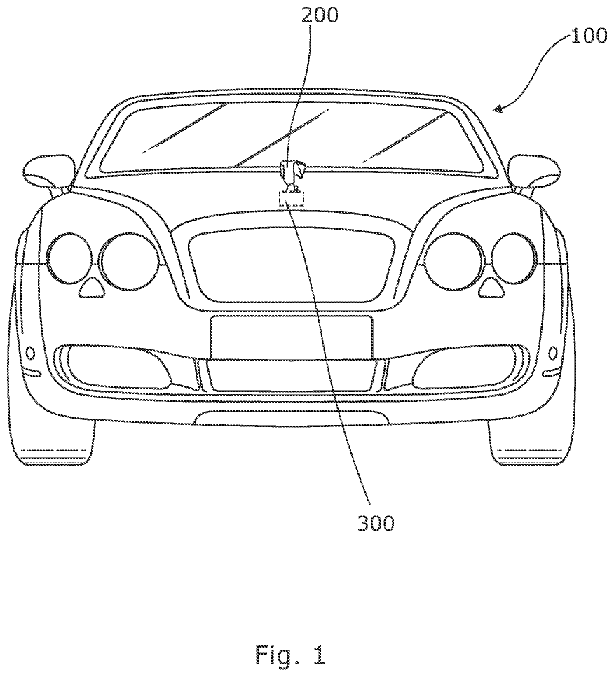

FIG. 1 shows an automobile comprising a mascot according to the present invention.

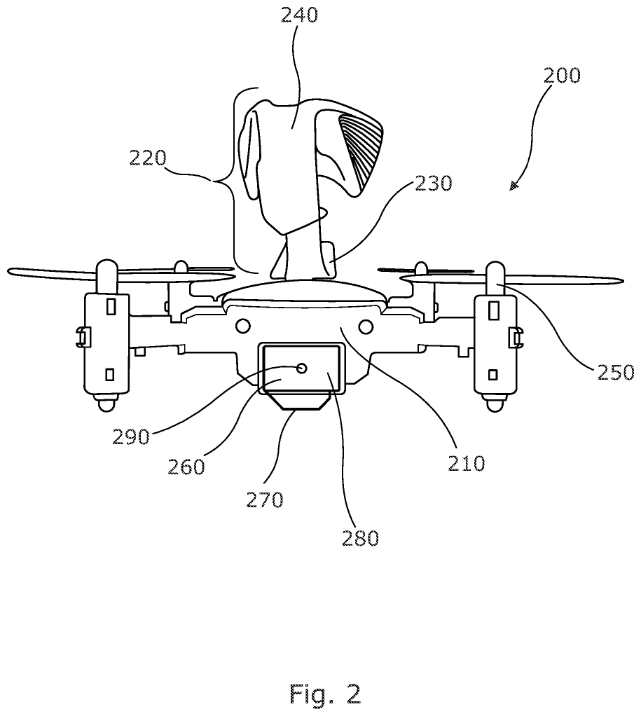

FIG. 2 shows a drone comprising a mascot according to the present invention.

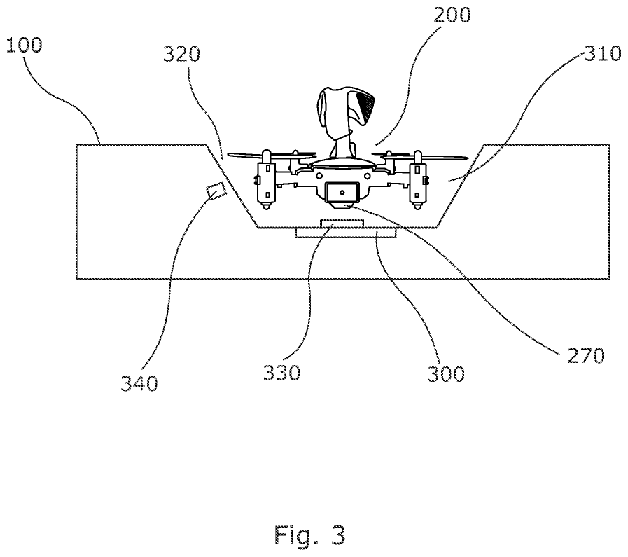

FIG. 3 shows a lateral cross-sectional view of the mascot attached to an automobile according to the present invention with the cover plate in the open position.

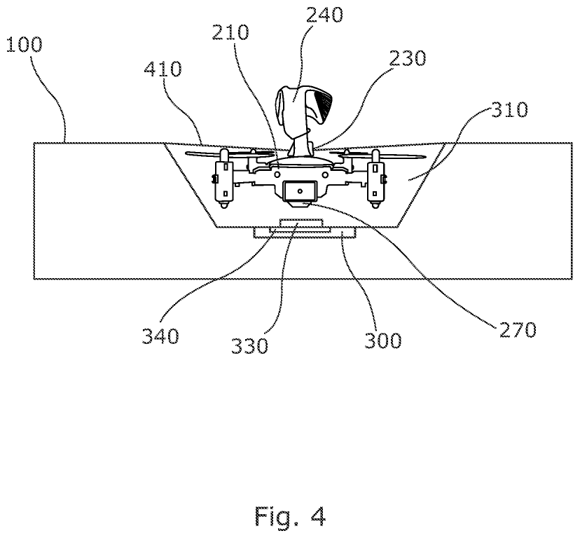

FIG. 4 shows a lateral cross-sectional view of the mascot attached to an automobile according to the present invention with the cover plate in the first closed position.

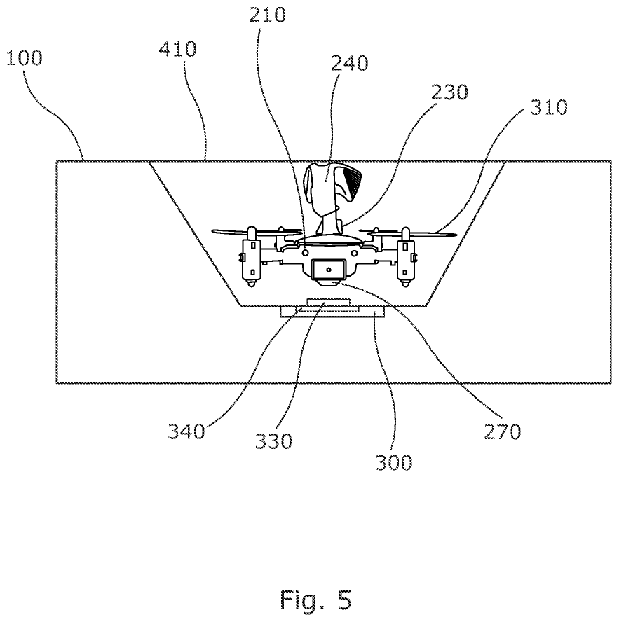

FIG. 5 shows a lateral cross-sectional view of the mascot attached to an automobile according to the present invention with the cover plate in the second closed position and the mascot and drone fully retracted inside of the aperture.

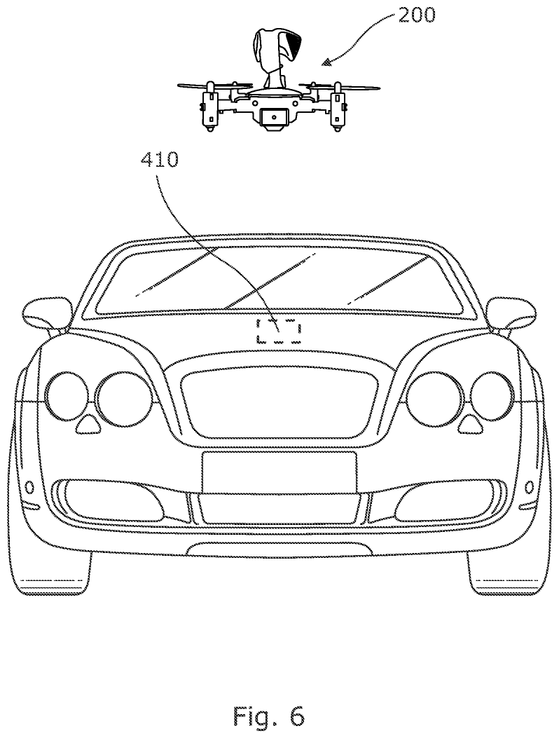

FIG. 6 Shows a front view of the mascot according to the present invention when disconnected from the vehicle.

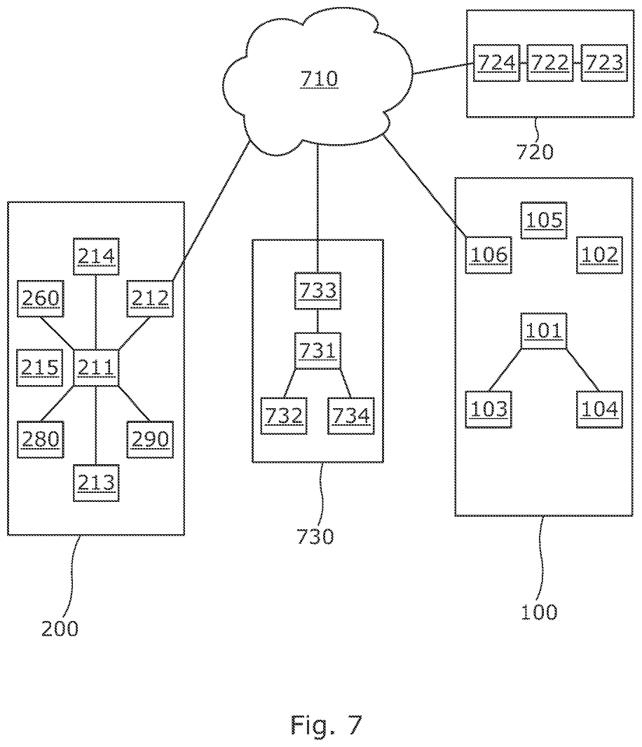

FIG. 7 shows a schematic diagram of the interaction between the drone and vehicle of the present invention.

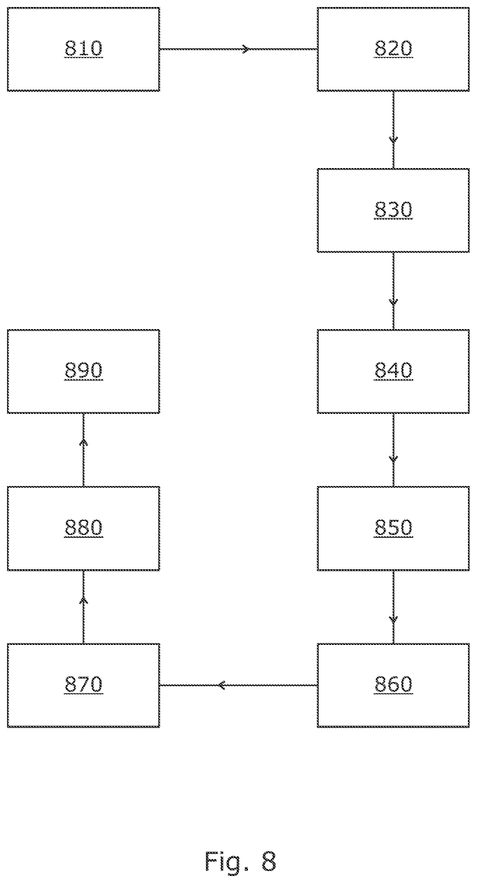

FIG. 8 Shows a schematic diagram of a method of operating a drone according to the third aspect of the present invention.

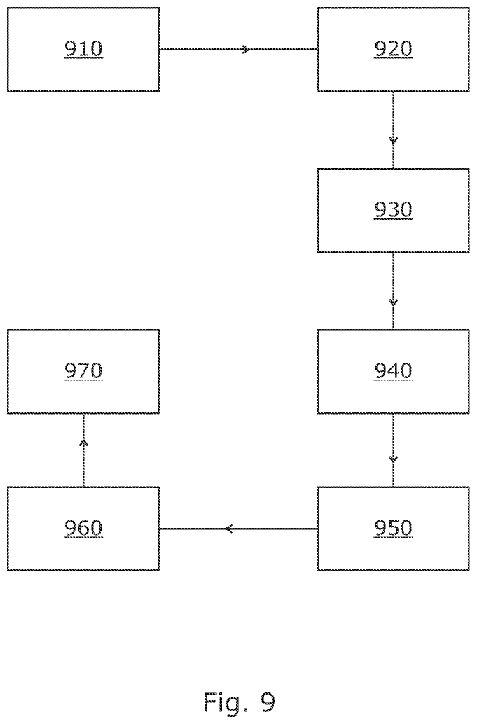

FIG. 9 Shows a schematic diagram of a method of operating a drone according to the fourth aspect of the present invention.

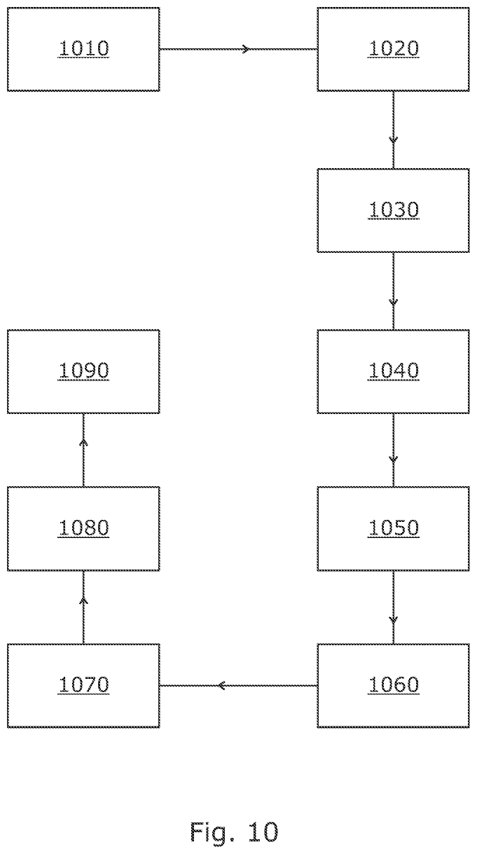

FIG. 10 Shows a schematic diagram of a method of operating a drone according to the fourth aspect of the present invention.

Suitable methods of operating a drone and the function of a drone, together with the communication of a drone with a vehicle are known in the art from at least US2020216196 and US10152059, accordingly, this description focusses on a vehicle comprising a mascot secured via a drone and the integration of the drone and mascot with the vehicle, and only briefly describes the operation of the drone.

With reference to FIG. 1, an automobile 100 is provided with a mascot 200 secured to the automobile 100 via a drone attached to the automobile at a landing point 300 located at the front of the automobile 100, in particular, centrally mounted at the front of the bonnet.

With reference to FIG. 2, the drone comprises a body 210 having an upper and lower surface. The upper surface of the drone comprises a mascot 220 attached thereto by an adhesive or via a breakaway nylon fixing such as those available from Louis Lejeune Ltd of Ely, Cambridgeshire (UK) that comply with EC Directive 74/483.

The mascot 220 comprises a base portion 230 for securing to the top surface of the drone and an upper portion 240 comprising a stylised, forward facing capital letter B from the rear of which extends two feathered wings; the iconic Bentley “Flying B”. The wings are at least partially formed from a semi-transparent material. A light (such as an LED) is positioned to the rear of the letter B to illuminate the wings The base portion 230 comprises a pedestal extending downward and backwards from the rear of the bottom of the letter B. Away from the B the pedestal thickens and extends into a base. The base portion 230 has a generally trapezoidal outline shape with rounded off corners and a flat underside.

The drone comprises four propellers 250 extending from its body 210 and comprises a camera 260 and motion sensor 280 located at the front of the body 210 and a processor located within the body 210.

The lower surface of the drone comprises a magnet 270 for connecting to the landing point of the automobile 300, shown in FIG. 3.

As shown in FIG. 3, the landing point 300 is located within a pocket 310 of an aperture 320 located at the front of the automobile 100 in front of the bonnet of the automobile 100.

The landing point 300 comprises a magnet 330 for connecting to the magnet 270 of the drone 200.

When connected to the landing point 300, the body 210 of the drone 200 is located within the pocket 310 of the aperture 320, such that only the mascot 230 protrudes through the aperture 320 in the radiator shell. The landing point 300 is in communication with the automobile's 100 infotainment system via electronic cables (not shown). The landing point has a pressure sensor 340 associated therewith for detecting the presence of the drone 200.

As best shown in FIG. 4, when the drone 200 is connected to the landing point 300, the aperture 310 is closable by a cover plate 410 which is arranged to close flush around the base portion 230 of the mascot 220 in a first closed position, such that only the upper portion 240 of the mascot is visible, and the body 210 of the drone is concealed beneath the cover plate 410.

The cover plate 410 is closed to a first closed position in response to a first ‘close’ signal provided by the automobile 100 upon connection of the drone 200 to the landing point 300.

In response to a user pressing a button to deploy the drone, such as by pressing a button on the infotainment screen, the automobile 100 provides an ‘open’ signal to an actuator that causes the first cover plate 410 to retract and open the aperture 310 to provide the open configuration shown in FIG. 3.

The automobile 100 then communicates with the drone 200 to launch the drone 200 from the automobile 100 through the aperture.

The user of the automobile 100 can use the automobile 100 infotainment system or other electronic device, such as a smart phone, to control the launch or landing of the drone 200 from the automobile 100, send navigation instructions (for example, up, down, left, right, forward, and backward) to the drone, and control the drone camera 260 (e.g. pan/yaw, tilt, zoom, record, switch between cameras, such as multi-colour, infrared, and night vision), and command the drone 200 to follow the automobile 100 or move to any co-ordinate position. The drone 200 can also autonomously control itself. For example, the on-board computer system of the drone 200 can cause the drone 200 to take off and land without user input.

Once the drone 200 has been deployed from the automobile 100, the automobile 100 sends a second ‘close’ signal to actuate the cover plate 410 to fully close the aperture 310 to a second, completely closed configuration. The cover plate 310 fits flush to the exterior surface of the automobile 100 thereby concealing the aperture 320 in the second closed configuration. Thus, when the drone 200 is deployed away from the automobile 100, as shown in FIG. 5, the aesthetic appearance of the automobile 100 is maintained.

When the drone 200 is required to land, the automobile 100 may determine a landing instruction for landing the drone 200 on the landing point 300 located within the aperture 310. The landing instructions may include location, time, speed, and other relevant information indicating where and when the drone 200 will land.

Once the drone 200 is in the vicinity of the aperture of the automobile 100, the automobile 100 sends an ‘open’ signal to retract the cover plate 410 exposing the landing point 300 located within the aperture 310, as shown in FIG. 3.

The drone 200 is then free to land and magnetically connects to the landing point 300 to secure the drone 200 into position.

Once connected to the landing point 300, the automobile sends a ‘close’ signal to the cover plate 410 thereby closing the cover plate 410 to the first closed configuration so that it sits flush around the base 230 of the mascot, such that only the upper portion 240 is visible with the body 210 of the drone being concealed beneath the cover plate 410.

As shown in FIG. 5, when the driver is leaving the automobile, a third ‘close signal is provided by pressing a lock button on a remote ignition key. Upon providing the third 'close’ signal, the landing point 300 is lowered by an electronic drive mechanism (not shown) such that the drone body 210 and upper portion 240 and base portion 230 of the mascot 220 are positioned below the external surface of the automobile 100. The cover plate 410 is then closed to the second ‘closed’ position. This allows the entirety of the drone 200 to be secured inside of the automobile 100 to prevent theft or damage.

Upon returning to the automobile 100, a second ‘open’ signal may be provided by pressing an ‘unlock’ button on a remote ignition key. Upon providing the second ‘open’ signal, the cover plate 410 is actuated to the first ‘closed’ position and the landing point 300 is raised to the first closed configuration such that the cover plate 410 sits flush around the base 230 of the mascot with only the upper portion 240 visible and the body 210 of the drone 200 being concealed beneath the cover plate 410.

As shown in FIG. 7, the drone 200 comprises a processor 211 coupled to a camera 260, motion sensor 280, light 290, lithium ion battery power supply 213 and a navigation system 214, for example a GPS navigation system. The processor is also coupled to a memory 215 and a communication unit 212 for communication with a communication network 710, such as a 3G, 4G or 5G network.

The automobile includes a processor 101 coupled to a user interface 102, navigation system 103 and a display screen 104. The processor 101 is also connected to a memory 105 and a communication unit 106 for communicating with the communication network 710.

In addition to communicating with the drone 200 through the automobile 100, the user may also communicate with the drone 200 through a remote ignition key 720 or smart phone 730.

The smart phone may comprise a processor 731 coupled to a user interface 732, navigation system 734 and a communication unit 733 for communicating with the communication network 710.

The remote ignition key 720 may comprise a processor 722 coupled to an input button 723 and a communication unit 724 for communicating with the communication network 710.

As shown schematically in FIG. 8, the drone 200 may be used to provide images of the road along a navigation route. This can allow the driver to view road conditions up ahead, such as, for example, to determine the cause of traffic congestion up ahead.

In a first step 810, to deploy the drone 200, the user presses a button on a user interface 102 of the automobile 100. The user interface may be an automobile 100 infotainment system.

In a second step 820, the automobile 100 outputs an ‘open’ signal to an actuator that, in response to the ‘open’ signal, opens an aperture, such as a door, trunk or cover plate 410.

In a third step 830, once the aperture is opened, the drone 200 is deployed from the automobile 100.

Once deployed, in a fourth step 840, the user enters a reference point through the user interface 102 of the automobile 100 along the present navigation route programmed into the automobile 100.

In another embodiment, in a fourth step 840, the user simply indicates that they require further information on traffic conditions by pressing a button on the user interface 102 of the automobile 100 or user interface 732 of a smart phone 730, or the drone 200 determines its reference point based on traffic data, such as, for example, seeking the next congested section on a planned route. The congested section may be indicated by a red or black section on a planned route on a navigation system 103 of the vehicle, drone 214 or smart phone 734.

In a fifth step 850, the communication unit 106 of the automobile 100 sends navigational details of the reference point to a communication unit 212 of the drone 200 via the communication network 710.

In a sixth step 860, details of the reference point are then sent from the communication unit 212 to the navigation system 214 of the drone 200.

In a seventh step 870, the drone 200 is programmed to fly to the reference point, where it is then programmed to take multiple images of the road using the camera 260.

In an eighth step 880, the images are then wirelessly sent from the communication unit 212 of the drone 200 to the communication network 710 and then onto the communication unit 106 of the automobile 100 via the communication network 710.

In a ninth step 890, the images are then displayed on the display screen 104 of the automobile 100, such as an infotainment system. The user may then determine what action to take based upon the results of the images-for example, if the images show a delay caused by temporary traffic lights, the driver may wait and continue on the same route, whereas if the images show a serious collision, the driver may change the route.

As shown schematically in FIG. 9, the drone 200 may also assist in locating the automobile 100. This may assist a user in locating an automobile 100 in a crowded parking space or help passengers locate an automobile 100.

In a first step 910, the user presses a button to deploy the drone 200 on a user interface 732, such as a touch screen, of a smart phone 730.

In a second embodiment, in a first step 910, the user presses a button 723 on a remote ignition key 720 to deploy the drone 200.

In a second step 920, the communication unit 724 of the remote ignition key 720 or communication unit 733 of the smart phone 730 issues a deployment signal to a communication unit 106 of the automobile 100 via a communication network 710, such as a 4G or 5G cellular communication network.

In a third step 930, the automobile 100 then outputs an ‘open’ signal to an actuator.

In a fourth step 940, in response to the ‘open’ signal, the actuator opens an aperture, such as a door, trunk or cover plate 410 to deploy the drone 200.

In a fifth step 950, once the drone 200 is deployed, the communication unit 106 of the automobile 100 sends a command for the drone 200 to hover above the automobile 100 to the communication unit 212 of the drone 200 via the communication network 710

In a sixth step 960, once the command is received by the communication unit 212 of the drone 200, the drone 200 is programmed to hover over the automobile 100 at a distance of approximately 1m directly upwards from the roof of the automobile 100.

In a seventh step 970, once hovering over the automobile 100, the drone 200 is programmed to activate a flashing light 290.

In one embodiment wherein the drone is a drone according to a first aspect of the invention, the flashing light 290 is located in the upper portion of the mascot.

This makes the automobile 100 easier to locate by the user.

In a third embodiment, as detailed in FIG. 10, in a first step 1010, the user presses a button to deploy the drone 200 on a user interface 732, such as a touch screen, of a smart phone 730.

In a second step 1020, the communication unit 733 of the smart phone 730 issues a deployment signal to a communication unit 106 of the automobile via a communication network 710, such as a 4G or 5G cellular communication network.

At the same time, the navigation system 734 of the smart phone 730 also sends the position of the user to the communication unit 733 of the smart phone 730 and onto the communication unit 106 of the automobile 100 via the communication network 710.

In a third step 1030, the automobile 100 then outputs an ‘open’ signal to an actuator of an aperture of the vehicle.

In a fourth step 1040, the actuator in response to the ‘open’ signal, opens an aperture, such as a door, trunk or cover plate 410 to deploy the drone 200.

In a fifth step 1050, once the drone 200 is deployed, the communication unit 106 of the automobile 100 then sends a command to the communication unit 212 of the drone 200 via the communication network 710 for the drone 200 to go to the user's position.

In a sixth step 1060, once the command is received by the communication unit 212 of the drone 200, the drone proceeds to the user's position.

In a seventh step 1070, once the drone 200 has reached the user, the communication unit 212 of the drone 200 communicates back to the communication unit 106 of the automobile 100 through the communication network 710 that it has reached the user's position.

In an eighth step 1080, the navigation system 103 of the automobile 100 then sends details of the automobile's position to the communication unit 106 of the automobile 100 and then onto the communication unit of the drone 212 via the communication network 710, together with a command for the drone 200 to return to the automobile 100.

In a ninth step 1090, once the command is received by the communication unit 212 of the drone 200, the drone 200 returns to the automobile 100.

This allows the user to follow the drone and be guided back to the automobile 100.

The one or more embodiments are described above by way of example only. Many variations are possible without departing from the scope of protection afforded by the appended claims.

1. A vehicle comprising a mascot and a drone; wherein the mascot is secured to the drone and the drone is secured to the vehicle.

2. A vehicle according to claim 1, wherein the drone comprises a body and wherein the mascot comprises a base portion and an upper portion.

3. A vehicle according to claim 2, wherein the base portion of the mascot is secured to an upper surface of the body of the drone and wherein the upper portion of the mascot comprises an ornament.

4. A vehicle according to claim 2, wherein a lower surface of the body of the drone comprises one or more connection points configured to secure to the vehicle.

5. A vehicle according to claim 1, wherein the vehicle comprises a landing point for connecting to the drone, preferably wherein the landing point is located on an outer surface of the vehicle, preferably at the front and centre of the vehicle.

6. A vehicle according to claim 5, wherein the landing point is configured to magnetically connect to the drone.

7. A vehicle according to claim 5, wherein the landing point comprises one or more sensors, preferably a pressure sensor.

8. A vehicle according to claim 5, wherein the landing point is located within an aperture on an outer surface of the vehicle.

9. A vehicle according to claim 8, wherein the aperture has one or more cover plates having an outer surface arranged to close the aperture.

10. A vehicle according to claim 9, wherein the outer surface of the cover plate is arranged to be flush around a base portion of the mascot in a first closed position.

11. A vehicle according to claim 9, wherein the cover plate is configured to enter the first ‘closed’ position when a first ‘close’ signal is provided, preferably wherein the first ‘close’ signal is provided when the landing point is occupied.

12. A vehicle according to claim 8, wherein the outer surface of the cover plate is arranged to fully close the aperture in a second closed position.

13. A vehicle according to any claim 12, wherein the cover plate is configured to enter the second closed position when a ‘second’ close signal is provided, preferably wherein the second ‘close’ signal is provided when the landing point is vacant.

14. A vehicle according to claim 9, wherein the cover plate is configured to open the aperture and enter an open position when a first ‘open’ signal is provided, preferably wherein the first ‘open’ signal is provided by pressing a button to deploy the drone on a key, vehicle infotainment system, smart phone or other electronic device.

15. A vehicle according to claims 9, wherein the cover plate is configured to enter a second ‘closed’ position wherein the outer surface of the cover plate is arranged to fully close the aperture and the landing point is configured to lower, such that the drone and mascot are concealed beneath the cover plate, when a third ‘close’ signal is provided, preferably wherein the third ‘close’ signal is provided by pressing a lock button on a key, or pressing a lock button on a smart device, smart phone or other electronic device.

16. A vehicle according to claim 9, wherein the cover plate is configured to enter a first ‘closed’ position, wherein the outer surface of the cover plate is arranged to be flush around a base portion of the mascot, and the landing point is configured to raise such that the outer surface of the cover plate conceals the body of the drone and the mascot extends through the cover plate when a second ‘open’ signal is provided.

17. A vehicle according to claim 16, wherein the second open signal is provided by pressing an unlock button on a key, auto detection using keyless entry, operating a door handle, pushing of an ignition button, turning of an ignition key, or pressing an unlock button on a smart phone or other electronic device.

18. A drone comprising a mascot, wherein the drone is configured to be secured to a vehicle to mount the mascot thereto.

19. A drone according to claim 18, wherein the drone comprises one or more components selected from the group comprising a processor, a navigation system, a memory, a display, image sensor, motion sensor, positioning sensor, power source, communication unit, and combinations thereof.

20. A method of providing one or more images along a navigation route comprising: deploying a drone according to claims 18 to fly to one or more points along a navigation route between a start position and a user inputted final destination, taking one or more images at the one or more points, sending the images to a vehicle according to claim 1 and displaying said images via a display inside the vehicle.

21. A method for locating a vehicle, the method comprising: sending a deployment signal to a vehicle according to claim 1, deploying a drone according to claim 18 from the vehicle in response to receiving the deployment signal, configuring the drone to hover above the vehicle and configuring said drone to provide one or more alerts.

22. A method according to claim 21, wherein the drone is configured to hover over the vehicle at a distance of no more than 2.0m directly upwards from the vehicle.

23. A method according to claim 21, wherein the deployment signal is provided by pressing a button on a remote ignition key or by pressing a button on a vehicle infotainment system.

24. A method according to claim 21, wherein after deployment of the drone, the method further comprises the steps of: sending a command for the drone to exit the vehicle and locate the user; configuring the drone to fly to the user's position in response to receiving the command to exit the vehicle and locate the user; sending a command for the drone to return to the vehicle; and configuring the drone to return to the vehicle in response to receiving the command for the drone to return to the vehicle.

25. A method for locating a vehicle, the method comprising: sending a deployment signal to a vehicle according to claim 1; deploying a drone according to claim 18 from the vehicle in response to receiving the deployment signal; sending a command for the drone to exit the vehicle and locate the user; configuring the drone to fly to the user's position after receiving the command for the drone to exit the vehicle and locate the user; sending a command for the drone to return to the vehicle; and configuring the drone to fly back to the vehicle after receiving the command for the drone to return to the vehicle.
